(19) United States
(12) Patent Application Publication
(10) Pub. No.: US 2014/0365218 A1
(43) Pub. Date: Dec. 11, 2014

(54) LANGUAGE MODEL ADAPTATION USING RESULT SELECTION

(71) Applicant: Microsoft Corporation, Redmond, WA (US)

(72) Inventors: Shuangyu Chang, Fremont, CA (US); Michael Levit, San Jose, CA (US)

(21) Appl. No.: 13/913,032

(22) Filed: Jun. 7, 2013

(51) Int. Cl. G10L 15/065; G10L 15/06; G10L 15/02

(52) U.S. Cl. CPC G10L 15/065; G10L 15/02; G10L 15/063
USPC 704/244

(57) ABSTRACT

A received utterance is recognized using different language models. For example, recognition of the utterance is independently performed using a baseline language model (BLM) and using an adapted language model (ALM). A determination is made as to what results from the different language model are more likely to be accurate. Different features may be used to assist in making the determination (e.g. language model scores, recognition confidences, acoustic model scores, quality measurements, . . . ) may be used. A classifier may be trained and then used in determining whether to select the results using the BLM or to select the results using the ALM. A language model may be automatically trained or re-trained that adjusts a weight of the training data used in training the model in response to differences between the two results obtained from applying the different language models.

### BACKGROUND

There are many applications for using speech recognition including searching, command and control, spoken dialog systems, natural language understanding systems, and the like. These speech systems may use a language model to assist in understanding the received spoken input. A common scenario in language modeling for automatic speech recognition is to adapt a baseline language model using additional training material for a targeted application (e.g. text sentences, transcribed/un-transcribed spoken utterances). For example, adaptation may be performed by interpolating the baseline language model with another language model that is trained using the additional material.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A received utterance is recognized using different language models. For example, recognition of the utterance is independently performed using a baseline language model (BLM) and using an adapted language model (ALM). After performing recognition on the utterance using each of the different language models, an automatic determination is made as to what results from the different language models are more likely to be accurate. Different features may be used to assist in making the determination. For example, language model scores, recognition confidences, acoustic model scores, quality measurements (e.g. Signal to Noise Ratio “SNR”, clip rate), and the like may be used. A classifier is trained and then used in determining whether to select the results from the recognition performed using the BLM or to select the results from the recognition performed using the ALM. A language model may also be automatically trained or re-trained using training data that is adjusted in response to differences between the two results obtained from using the different language models. For example, a subset of training data for training an adapted language model may be automatically selected and reweighted based on a determination that the adapted model's result for the training data is likely to be worse than the baseline model's result for the same training data.

### BRIEF DESCRIPTION OF THE DRAWINGS

FIG. 1 shows a system for language model adaption using result selection;

FIG. 2 shows a process for training a classifier using recognition results obtained by using different language models;

FIG. 3 illustrates a process for selecting results from a baseline language model or selecting results from an adapted language model;

FIG. 4 shows a method for training a language model using reweighted unsupervised data;

FIG. 5 illustrates an exemplary online system that selects results from using a baseline language model and an adapted language model; and

FIGS. 6, 7A, 7B and 8 and the associated descriptions provide a discussion of a variety of operating environments in which embodiments of the invention may be practiced.

### DETAILED DESCRIPTION

Referring now to the drawings, in which like numerals represent like elements, various embodiment will be described elements, various embodiment will be described.

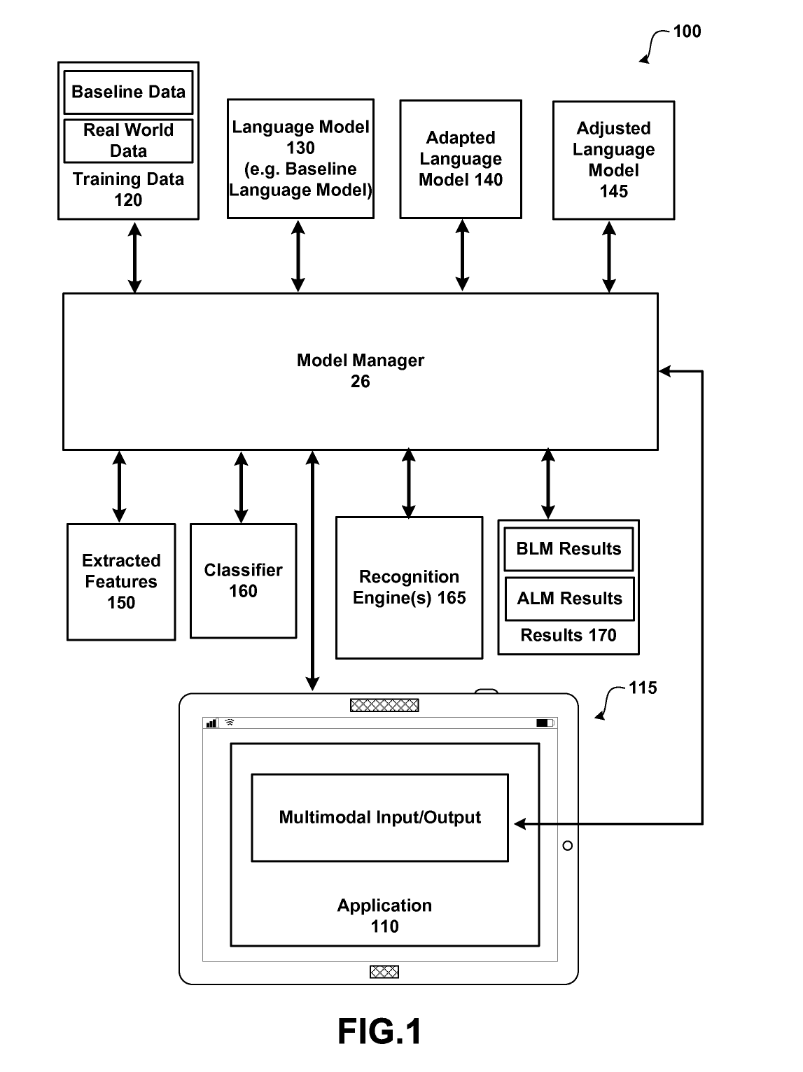

FIG. 1 shows a system for language model adaption using result selection.

As illustrated, system 100 includes model manager 26, training data 120, language model 130, adapted language model 140, adjusted language model 145, extracted features 150, classifier 160, recognition engine(s) 165, results 170, application 110 (e.g. a speech related application) and touch screen input device 115.

Model manager 26 is configured to determine when recognition output results using a language model (LM) 130 (e.g. a baseline language model (BLM)) are more likely to be accurate (e.g. correct) as compared to the recognition output results from an adapted language model (ALM) 140. A language model (e.g. language model 130, adapted language model 140, adjusted language model 145) includes statistical information that is used in speech recognition to recognize the words in an utterance. Generally, model manager 26 provides an utterance to a language model and receives recognition output results for the utterance using the language model. Model manager 26 automatically selects the results from the LM that are more likely to be accurate for a received utterance. According to an embodiment, model manager 26 may also be configured to automatically train or re-train a language model, such as adapted language mode 140 or adjusted language model 145 that adjusts a weight of items within training data 120 to account for detected differences between the recognition output results received from the different language models.

LM 130 may be a BLM that is created from training data that is based on an estimate of potential real user utterances or created using some other method. For example, an application, such as application 110, may be used to capture utterances received from users who are interacting with application 110. These captured utterances may be used as training data for training a language model.

Generally, ALM 140 is a language model that is trained using additional training data as compared to the training data used for training the BLM. After training ALM 140, the ALM is interpolated with the BLM. For example, ALM 140 may be created using training data including all or a portion of the received user utterances and the training data used in training the BLM. ALM 140 is then interpolated with the BLM. Different interpolation weights may be used when interpolating the ALM with the BLM. The interpolation weights determine how much each language model contributes to interpreting an utterance. An ALM trained using this method, however, does not always perform better than the BLM on many received utterances. The ALM may not even perform as well on recognizing an utterance as compared to recognition of the utterance using the BLM. The worse performance of the ALM may occur for various reasons. For example, there may be recognition errors in the unsupervised transcription data, biases in other parts of the recognition system (e.g. the acoustic model and the decoder), and the like. These errors may even be reinforced through the training process.

Some utterances are recognized more accurately when using BLM 130 whereas other utterances are recognized more accurately when using ALM 140. For an arbitrary utterance received by system 100, there are different possible outcomes when the utterance is recognized by model manager 26 using each of the two LMs independently, including: 1) both LMs are correct; 2) both LMs are incorrect; 3) the BLM is correct but the ALM is incorrect; and 4) the BLM is incorrect but the ALM is correct.

Model manager 26 may be used online when processing utterances received from an application or offline during training. For example, model manager 26 may be used online to process utterances received from an application, such as application 110. Model manager 26 may be used offline to assist in training a language model and/or training a classifier, such as classifier 160. According to an embodiment, classifier 160 is a statistical classifier that is trained using extracted features 150 obtained from results 170. After training, classifier 160 is used by model manager 26 during an online phase to assist in determining whether the BLM results are more accurate than the ALM results or the ALM results are more accurate than the BLM results for a received utterance.

Model manager 26 is configured to receive an utterance, such as from application 110, and automatically perform recognition on the utterance using different language models. According to an embodiment, recognition of the utterance is performed using BLM 130 and ALM 140. For each received utterance, recognition of the utterance is independently performed using each of the language models. A recognition result is output by each different language model (e.g. BLM results obtained by performing recognition using BLM 130 and ALM results obtained by performing recognition using ALM 140). While two language models are used in the recognition, more language models may be used.

Model manager 26 extracts one or more features from each of the different results. The features may include, but are not limited to: a language model score for each of the different language models performing recognition, recognition confidences, an acoustic model score, quality measurements (e.g. Signal to Noise Ratio “SNR”, clip rate), and the like. For example, a language model score may be assigned to each recognition output by the recognition engine (e.g. recognition engine(s) 165)) that indicates a likelihood of the result being correct given the language model used to generate the recognition output results. In some cases, a recognition engine may provide a recognition confidence in addition to providing a language model score or in place of providing a language model score. Model manager 26 applies trained classifier 160 to determine whether to select the ALM results or the BLM results.

When the ALM results are determined to be more accurate than the BLM results, model manager 26 selects the ALM results. When the BLM results are determined to be more accurate than the ALM results, model manager 26 selects the BLM results.

Model manager 26 may also be configured to train or re-train a language model using recognition results obtained from different language models. For example, adjusted LM 145 may be automatically trained using training data (e.g. training data 120) that is adjusted 1 in response to the detected differences between the different results.

Using the results of the classifier 160, model manager 26 may automatically identify a subset of training data from training data 120 that is likely to not be as accurate when using the ALM as compared to the accuracy when using the BLM. A set of statistics on the Ngram differences between the two results on this subset is computed and these statistics are then used to reweight or filter the training data. An Ngram is a sequence of items (e.g. phonemes, syllables, letters, . . . ) from a sequence of text or speech. This reweighted or filtered data set may then be used to train another language model (e.g. adjusted language model 145) or retrain a language model (e.g. adapted language model 140).

In order to facilitate communication with the model manager 26, one or more callback routines, may be implemented. According to one embodiment, application 110 is a multimodal application that is configured to receive speech input (e.g. utterances) and to perform an action in response to receiving the utterance. Application 110 may also receive input from a touch-sensitive input device 115 and/or other input devices. For example, voice input, keyboard input (e.g. a physical keyboard and/or SIP), video based input, and the like. Application program 110 may also provide multimodal output (e.g. speech, graphics, vibrations, sounds, . . . ).

Model manager 26 may provide information to/from application 110 in response to user input (e.g. speech/gesture). For example, a user may say a phrase to identify a task to perform by application 110 (e.g. performing a search, selecting content, buying an item, identifying a product, . . . ). Gestures may include, but are not limited to: a pinch gesture; a stretch gesture; a select gesture (e.g. a tap action on a displayed element); a select and hold gesture (e.g. a tap and hold gesture received on a displayed element); a swiping action and/or dragging action; and the like.

System 100 as illustrated comprises a touch screen input device 115 that detects when a touch input has been received (e.g. a finger touching or nearly teaching the touch screen).

Model manager 26 may be part of a speech system, such as a dialog system that receives speech utterances and is configured to extract the meaning conveyed by a received utterance. More details are provided below.

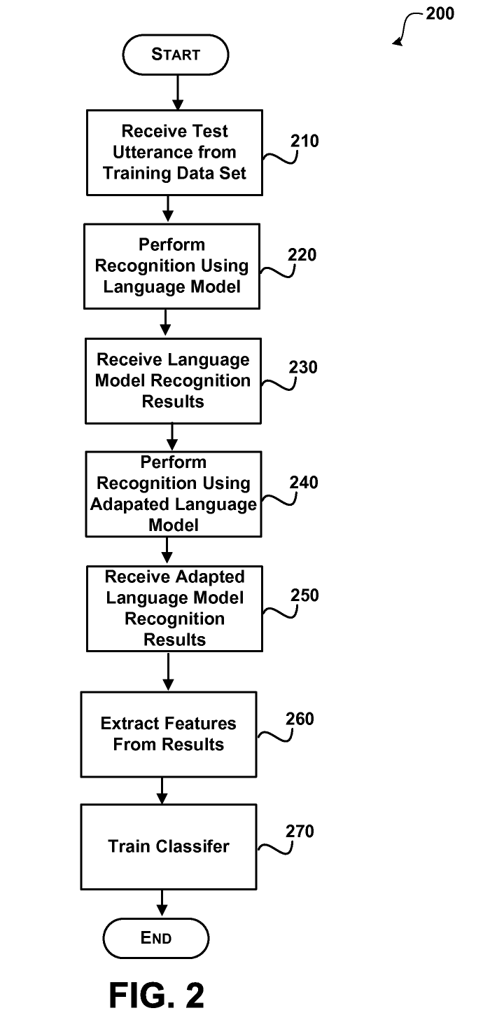

FIGS. 2-4 illustrate using language model adaption using result selection. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof. While the operations are shown in a particular order, the order of the operations may change, be performed in parallel, depending on the implementation.

FIG. 2 shows a process for training a classifier using recognition results obtained by using different language models.

After a start operation, process 200 moves to operation 210, where test utterances are received. For example, test utterances may be received from a transcribed training data set. According to an embodiment, each test utterance in the training data set is manually transcribed. The test utterances may be real world utterances received from one or more users. For example, the test utterances may be utterances received over a period of time from different users using a speech application. Operations 220-270 may be performed for all/portion of the test utterances in the training data set. Other training data sets may also be used.

Flowing to operation 220, recognition for the received test utterance is performed using a language model. According to an embodiment, the language model is a BLM.

Transitioning to operation 230, the BLM results are received in response to performing the recognition using the BLM. The BLM results may include an output hypothesis (e.g. recognition output string) as well as other information (e.g. language model score). According to an embodiment, the recognition output string is compared to the corresponding manual transcription of the received test utterance to determine if the BLM recognized the test utterance correctly or not.

Moving to operation 240, recognition of the test utterance is performed using an ALM. According to an embodiment, the adapted language model is a language model that is trained using additional training material as compared to the BLM and is then interpolated with the BLM.

Transitioning to operation 250, the ALM recognition results are received for the test utterance. The results may include an output hypothesis (e.g. recognition output string) as well as other information (e.g. language model score). According to an embodiment, the recognition output string is compared to the corresponding manual transcription of the received test utterance to determine if the ALM recognized the test utterance correctly or not.

Flowing to operation 260, one or more features are extracted from each of the results (the BLM results and the ALM results). According to an embodiment, one extracted feature is the difference between the language model scores of each recognition output string, with respect to the LM that the recognition was performed. For example, for an utterance x, recognition performed using the BLM gives a hypothesis x_{BLM} with LM score LMS(x_{BLM}) and recognition performed using the ALM gives a hypothesis x_{ALM} with LM score LMS(x_{ALM}). A difference between the ALM LM score and the BLM LM score is determined (e.g. LMS(x_{ALM})−LMS(x_{BLM})) in order to help indicate what language model is more accurate. The larger the negative value in the difference between the language scores indicates that it is more likely that the results using the BLM are correct and that the ALM results are incorrect. Correspondingly, the larger the positive value in the difference between the language scores indicates that it more likely the results using the ALM are correct and that the BLM results are incorrect.

Other features may also be extracted. For example, recognition confidences, Acoustic Model (AM) score differences, acoustic quality measures (e.g. Signal to Noise Ratio (SNR), clip rate), and the like may be extracted.

Moving to operation 270, a statistical classifier is trained. According to an embodiment, the LM score along with zero or more other features are used to train the classifier. Generally, the effectiveness of an extracted feature to train a classifier in selecting a result depends on a quality of recognition engine and acoustic model, as well as the quality of the BLM (e.g. a poorer baseline system typically results in greater number of regression pairs selected since there are greater amounts of deficiencies to exploit). After the classifier is trained it may be used in selecting results (e.g. BLM results or ALM results) that are determined to be more accurate (e.g. in an online system).

The process then moves to an end operation and returns to processing other actions.

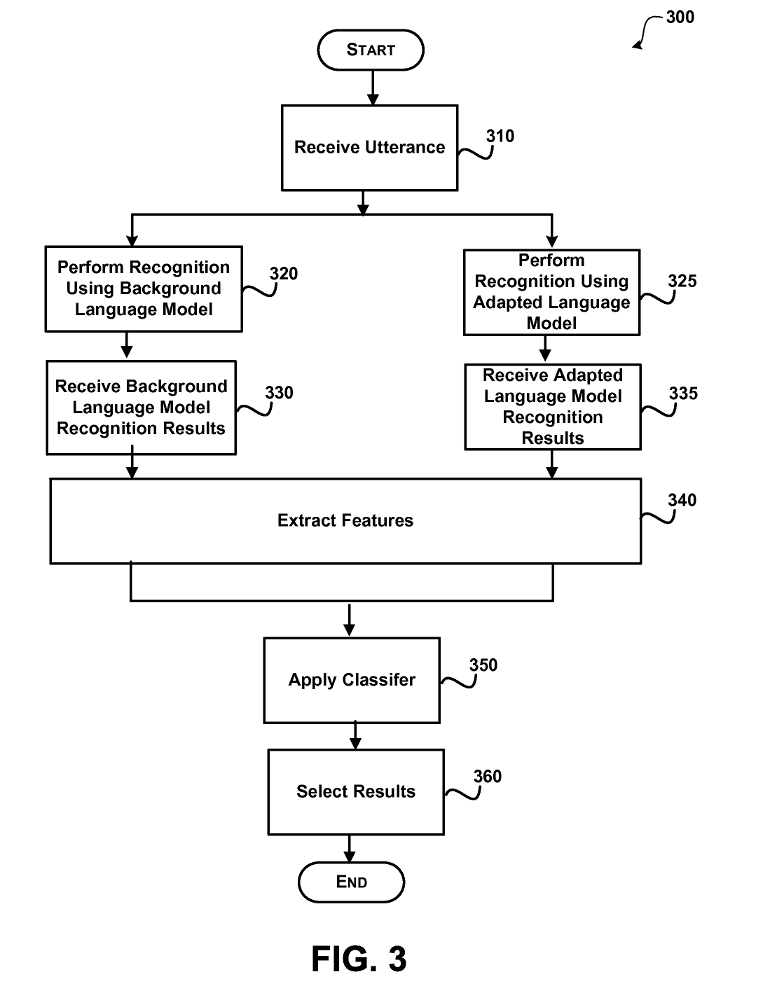

FIG. 3 illustrates a process for selecting results from a baseline language model or selecting results from an adapted language model.

After a start operation, process 300 moves to operation 310, where an utterance is received. According to an embodiment, an utterance is received from a user that is currently interacting with a speech application or service. For example, a user may speak an utterance to interact with an online service to search for content, perform an action, and the like.

Transitioning to operation 320 and operation 325, recognition is performed on the utterance using a BLM (320) and an ALM (325). Recognition using the different language models may occur in parallel or serially.

Flowing to operation 330 and operation 335, recognition results are received from performing the recognition using each of the different language models. Operation 330 receives the BLM recognition results and operation 335 receives the ALM recognition results. The results from performing recognition using each language model may include an output hypothesis (e.g. recognition output string) as well as other information (e.g. language model score).

Moving to operation 340, features are extracted from the different results. As discussed above, different features may be extracted from the different results. For example, a language model score may be obtained from each language model. Other features that may be extracted include, but are not limited to: recognition confidences, Acoustic Model (AM) scores or difference, acoustic quality measures (e.g. Signal to Noise Ratio (SNR), clip rate), and the like. According to an embodiment, an un-normalized log likelihood score may be computed using the language model recognition output and the adapted language recognition output. This log score may be used to select one of the results.

Flowing to operation 350, the classifier that was previously trained (See FIG. 2 and related description) is applied to the different results. The results from applying the classifier may be used in determining what results to select.

Moving to operation 360, the results from one of the language models are selected. For example, applying the classifier to the different results may favor the BLM results over the ALM results or may favor the ALM results over the BLM results. According to an embodiment, when neither result is favored (e.g. within some variance), either the ALM results or the BLM results may be selected.

The recognition and analysis of each LM results may be performed in parallel or serially. When the recognition and analysis is performed serially, results from a language model (e.g. BLM results or ALM results) may be selected before performing recognition using the other language model. For example, when recognition is first performed using the BLM model, and the BLM results have an acceptable recognition confidence, the BLM results may be selected without performing recognition using the ALM. Similarly, when recognition is first performed using the ALM model, and the ALM results have an acceptable recognition confidence, the ALM results may be selected without performing recognition using the BLM. An acceptable recognition confidence may be determined using different methods. For example, a threshold may be used to determine when a confidence score is above the threshold and/or other heuristics may be used.

The process then moves to an end operation and returns to processing other actions.

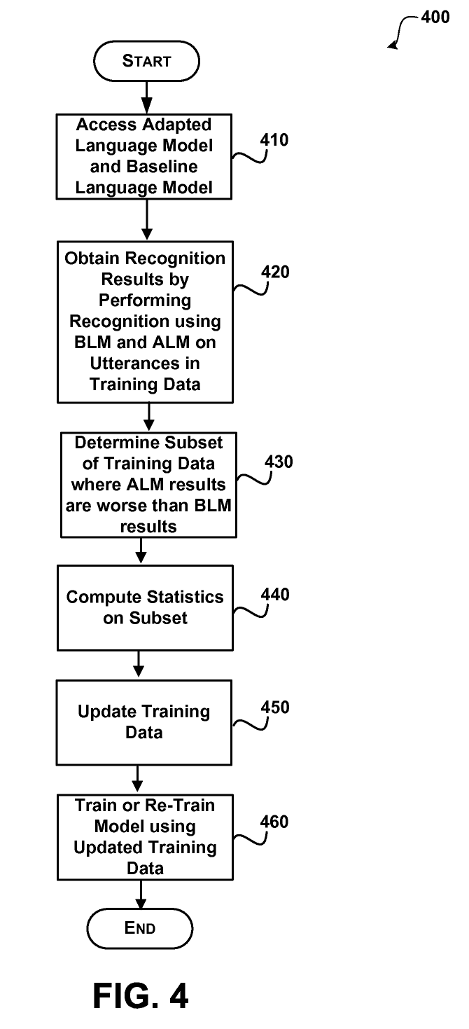

FIG. 4 shows a method for training a language model using reweighted unsupervised data.

After a start operation, process 400 flows to operation 410, where an ALM and BLM is accessed. As discussed above, an ALM may be created by training a language model using additional training material as compared to the BLM and interpolating the ALM with the BLM. The additional training material may include unsupervised data obtained using real world utterances. Unsupervised training data refers to utterances that are received and processed by a computing device without human interaction. Other training data may be used. According to an embodiment, the unsupervised data is filtered. For example, a simple confidence-based data filtering may be performed on the training data. According to another embodiment, the unsupervised data is non-filtered.

Moving to operation 420, recognition results are obtained by performing recognition on different utterances included in the training data using the BLM and performing an independent recognition on the different utterances in the training data using the ALM. According to an embodiment, the training data is data that is separate from the training data previously used to train the adapted language model.

Transitioning to operation 430, a subset of the training data that results in the ALM results being worse than the BLM results are determined (See FIGS. 2 and 3 above describing result selection). Generally, a portion of the training data will include utterances that are recognized better (more accurately) using the BLM as compared to the ALM. A subset of the training data where the ALM performs better than the BLM may also be determined.

Flowing to operation 440, statistics are computed using the two different results included in the determined subset. According to an embodiment, a set of statistics on Ngram differences between the two results on this subset are determined. Generally, Ngram differences are statistics of what Ngrams are contained in one recognition output string obtained from one language model but not contained in the other recognition output string obtained using the other language model. For each utterance in the subset, the Ngram differences are determined.

The following example is for descriptive purposes and is not intended to be limiting. For text strings T1 and T2, and an integer N, NgramDiff(T1; T2; N) is defined as an asymmetric Ngram set difference of order N between the two strings, consisting of the Ngrams of order N in T1, annotated by the difference in frequency of occurrences of each Ngram in T1 and T2. For example, if T1=“<s> a c d</s>” and T2=“<s> a b c</s>” where “<s>” and “</s>” are begin and end of sentence, respectively, then:

| | Ngrams | Diff |
|---|---|---|
| NgramDiff(T1; T2; 1) | d | 1 |
| NgramDiff(T1; T2; 2) | c d | 1 |
| | a c | 1 |
| | d </s> | 1 |
| NgramDiff(T1; T2; 3) | a c d | 1 |
| | c d </s> | 1 |
| | </s> a c | 1 |

In each case, the “Diff” count of “1” indicates that the particular Ngram occurred one more time in T1 than in T2 (actually each 1 and 0 times in this example, respectively). In this example, Ngrams have been omitted where the difference is less than 1.

Moving to operation 450, the training data is updated to reweight/filter the training data that results in poorer performance as compared to the BLM. For each utterance string in the unsupervised training data, a probability of accepting the string is determined by comparing the Ngrams in this string and the Ngram difference statistics from the subset. According to an embodiment, the formulation assigns lower probability to strings that contain more Ngrams that occur frequently in the Ngram difference statistics since they have been deemed harmful to recognition accuracy in the previous steps. For example, a formulation is: P(accept)=(1+Σᵢwₙ*NgramDiffScore(i))^{-E} where i ranges over the Ngrams of the current utterance that have a positive NgramDiffScore and Wn is a weighting factor for Ngrams of order n and −E in the exponent scales and inverts the score. Each utterance string is accepted or rejected based on the computed probability. According to an embodiment, the resulting set of accepted utterance strings are kept, and the rejected utterances are discarded.

Transitioning to operation 460, a language model is trained or re-trained using the updated training data. For example, a new language model may be created using the updated training data or an existing language model may be re-trained using the updated training data (e.g. Adapted Language Model 130 or Adjusted Language Model 145 as shown in FIG. 1). According to an embodiment, operations 420, 430, 440, 450 and 460 may be performed one or more further times to refine the language model. According to an example embodiment, it has been found that using the above method on an adapted language model may improve the sentence error rate reduction of the original adapted model by over 60 percent.

The process then moves to an end operation and returns to processing other actions.

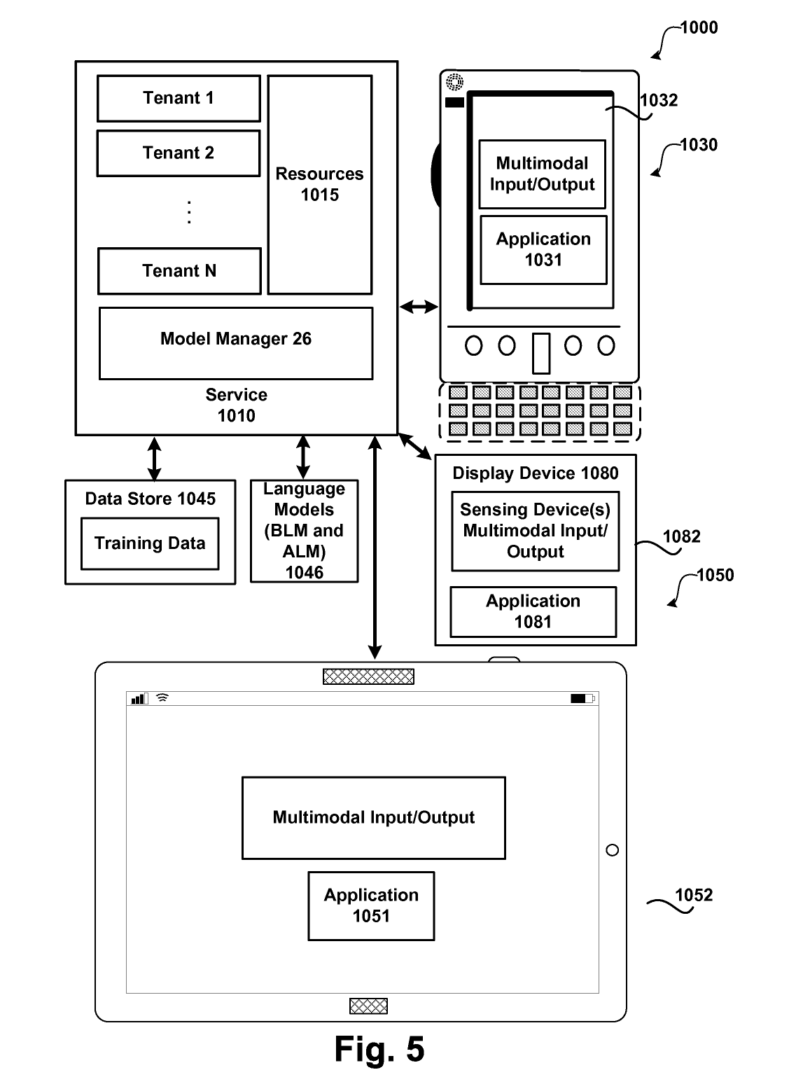

FIG. 5 illustrates an exemplary online system that selects results from using a baseline language model and an adapted language model. As illustrated, system 1000 includes service 1010, data store 1045, language models 1046 (e.g. ALM and BLM), touch screen input device 1050 (e.g. a slate), smart phone 1030 and display device 1080.

As illustrated, service 1010 is a cloud based and/or enterprise based service that may be configured to provide services, such as multimodal services related to various applications (e.g. searching, games, browsing, locating, productivity services (e.g. spreadsheets, documents, presentations, charts, messages, and the like)). The service may be interacted with using different types of input/output. For example, a user may use speech input, touch input, hardware based input, and the like. The service may provide speech output that combines pre-recorded speech and synthesized speech. Functionality of one or more of the services/applications provided by service 1010 may also be configured as a client/server based application.

As illustrated, service 1010 is a multi-tenant service that provides resources 1015 and services to any number of tenants (e.g. Tenants 1-N). Multi-tenant service 1010 is a cloud based service that provides resources/services 1015 to tenants subscribed to the service and maintains each tenant's data separately and protected from other tenant data.

System 1000 as illustrated comprises a touch screen input device 1050 (e.g. a slate/tablet device) and smart phone 1030 that detects when a touch input has been received (e.g. a finger touching or nearly touching the touch screen). Any type of touch screen may be utilized that detects a user's touch input. For example, the touch screen may include one or more layers of capacitive material that detects the touch input. Other sensors may be used in addition to or in place of the capacitive material. For example, Infrared (IR) sensors may be used. According to an embodiment, the touch screen is configured to detect objects that in contact with or above a touchable surface. Although the term “above” is used in this description, it should be understood that the orientation of the touch panel system is irrelevant. The term “above” is intended to be applicable to all such orientations. The touch screen may be configured to determine locations of where touch input is received (e.g. a starting point, intermediate points and an ending point). Actual contact between the touchable surface and the object may be detected by any suitable means, including, for example, by a vibration sensor or microphone coupled to the touch panel. A non-exhaustive list of examples for sensors to detect contact includes pressure-based mechanisms, micro-machined accelerometers, piezoelectric devices, capacitive sensors, resistive sensors, inductive sensors, laser vibrometers, and LED vibrometers.

According to an embodiment, smart phone 1030, touch screen input device 1050, and device 1080 are configured with multimodal applications and each include an application (1031, 1051, 1081) that is configured to receive speech input.

As illustrated, touch screen input device 1050, smart phone 1030, and display device 1080 shows exemplary displays 1052/1032/1082 showing the use of an application using multimodal input/output. Data may be stored on a device (e.g. smart phone 1030, touch screen input device 1050 and/or at some other location (e.g. network data store 1045). Data store 1045, or some other store, may be used to store training data as well as other data (e.g. language models such as a background language model and an adapted language model). The applications used by the devices may be client based applications, server based applications, cloud based applications and/or some combination. According to an embodiment, display device 1080 is a device such as a MICROSOFT XBOX coupled to a display.

Model manager 26 is configured to perform operations relating to selecting language model results and/or adapting a language model as described herein. While manager 26 is shown within service 1010, the functionality of the manager may be included in other locations (e.g. on smart phone 1030 and/or touch screen input device 1050 and/or device 1080).

The embodiments and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, the embodiments and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

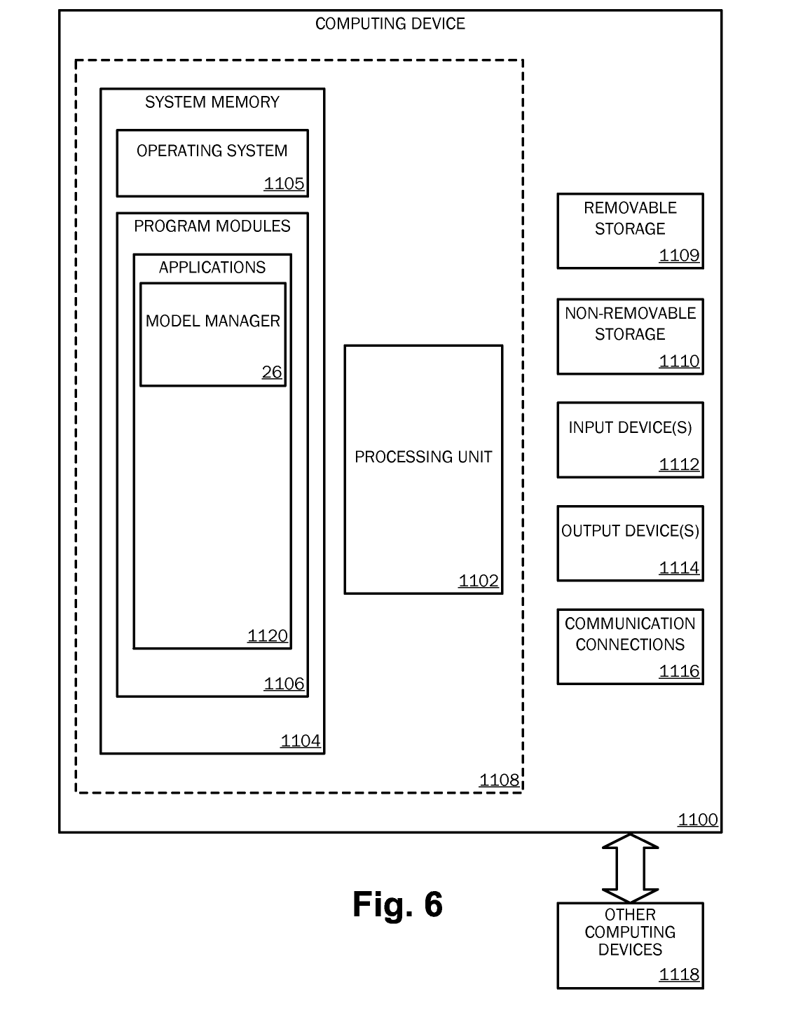

FIGS. 6-8 and the associated descriptions provide a discussion of a variety of operating environments in which embodiments of the invention may be practiced. However, the devices and systems illustrated and discussed with respect to FIGS. 6-8 are for purposes of example and illustration and are not limiting of a vast number of computing device configurations that may be utilized for practicing embodiments of the invention, described herein.

FIG. 6 is a block diagram illustrating physical components (i.e., hardware) of a computing device 1100 with which embodiments of the invention may be practiced. The computing device components described below may be suitable for the computing devices described above. In a basic configuration, the computing device 1100 may include at least one processing unit 1102 and a system memory 1104. Depending on the configuration and type of computing device, the system memory 1104 may comprise, but is not limited to, volatile storage (e.g., random access memory), non-volatile storage (e.g., read-only memory), flash memory, or any combination of such memories. The system memory 1104 may include an operating system 1105 and one or more program modules 1106 suitable for running software applications 1120 such as the model manager 26. The operating system 1105, for example, may be suitable for controlling the operation of the computing device 1100. Furthermore, embodiments of the invention may be practiced in conjunction with a graphics library, other operating systems, or any other application program and is not limited to any particular application or system. This basic configuration is illustrated in FIG. 6 by those components within a dashed line 1108. The computing device 1100 may have additional features or functionality. For example, the computing device 1100 may also include additional data storage devices (removable and/or non-removable) such as, for example, magnetic disks, optical disks, or tape. Such additional storage is illustrated in FIG. 6 by a removable storage device 1109 and a non-removable storage device 1110.

As stated above, a number of program modules and data files may be stored in the system memory 1104. While executing on the processing unit 1102, the program modules 1106 (e.g., the model manager 26) may perform processes including, but not limited to, one or more of the stages of the methods and processes illustrated in the figures. Other program modules that may be used in accordance with embodiments of the present invention may include electronic mail and contacts applications, word processing applications, spreadsheet applications, database applications, slide presentation applications, drawing or computer-aided application programs, etc.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the model manager 26 may be operated via application-specific logic integrated with other components of the computing device 1100 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

The computing device 1100 may also have one or more input device(s) 1112 such as a keyboard, a mouse, a pen, a sound input device, a touch input device, etc. The output device(s) 1114 such as a display, speakers, a printer, etc. may also be included. The aforementioned devices are examples and others may be used. The computing device 1100 may include one or more communication connections 1116 allowing communications with other computing devices 1118. Examples of suitable communication connections 1116 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 1104, the removable storage device 1109, and the non-removable storage device 1110 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1100. Any such computer storage media may be part of the computing device 1100. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

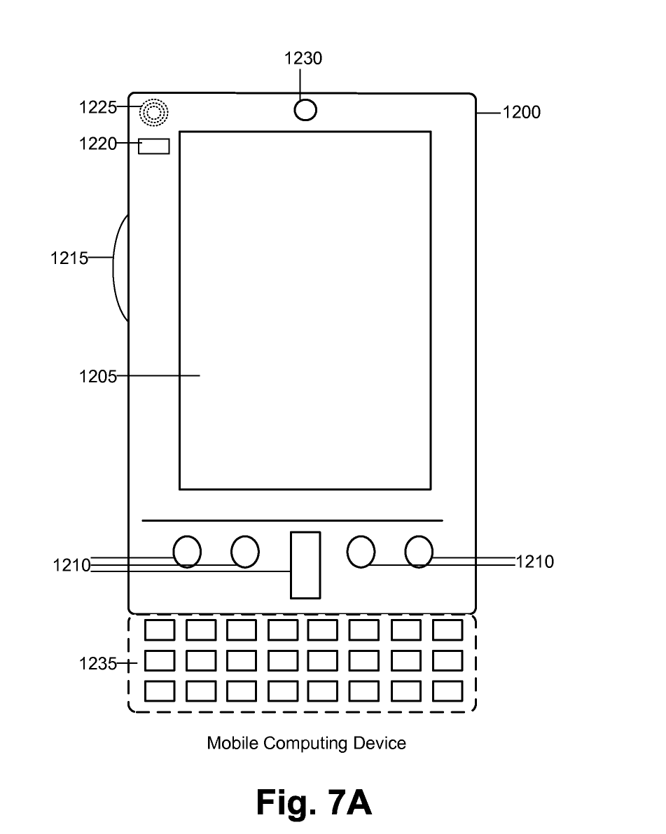

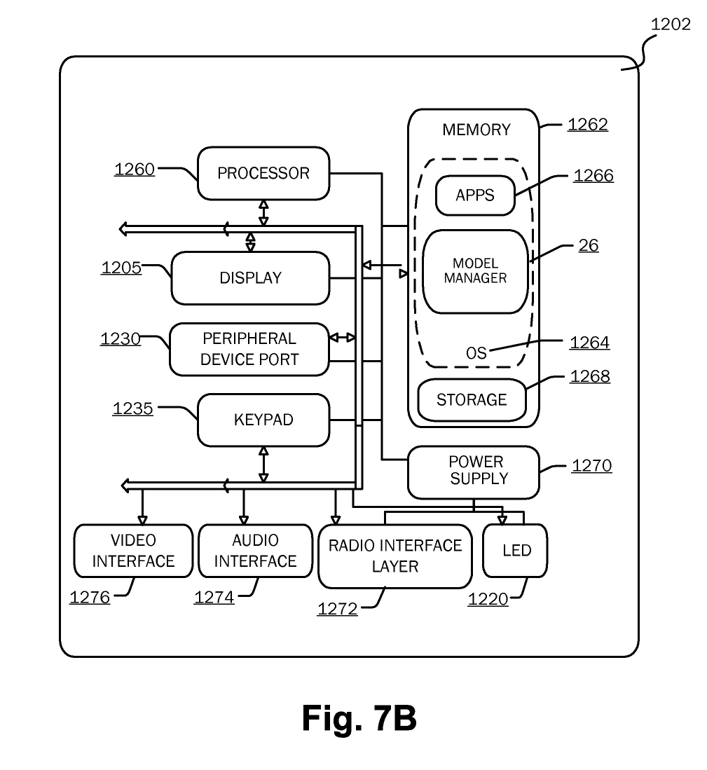

FIGS. 7A and 7B illustrate a mobile computing device 1200, for example, a mobile telephone, a smart phone, a tablet personal computer, a laptop computer, and the like, with which embodiments of the invention may be practiced. With reference to FIG. 7A, one embodiment of a mobile computing device 1200 for implementing the embodiments is illustrated. In a basic configuration, the mobile computing device 1200 is a handheld computer having both input elements and output elements. The mobile computing device 1200 typically includes a display 1205 and one or more input buttons 1210 that allow the user to enter information into the mobile computing device 1200. The display 1205 of the mobile computing device 1200 may also function as an input device (e.g., a touch screen display). If included, an optional side input element 1215 allows further user input. The side input element 1215 may be a rotary switch, a button, or any other type of manual input element. In alternative embodiments, mobile computing device 1200 may incorporate more or less input elements. For example, the display 1205 may not be a touch screen in some embodiments. In yet another alternative embodiment, the mobile computing device 1200 is a portable phone system, such as a cellular phone. The mobile computing device 1200 may also include an optional keypad 1235. Optional keypad 1235 may be a physical keypad or a “soft” keypad generated on the touch screen display. In various embodiments, the output elements include the display 1205 for showing a graphical user interface (GUI), a visual indicator 1220 (e.g., a light emitting diode), and/or an audio transducer 1225 (e.g., a speaker). In some embodiments, the mobile computing device 1200 incorporates a vibration transducer for providing the user with tactile feedback. In yet another embodiment, the mobile computing device 1200 incorporates input and/or output ports, such as an audio input (e.g., a microphone jack), an audio output (e.g., a headphone jack), and a video output (e.g., a HDMI port) for sending signals to or receiving signals from an external device.

FIG. 7B is a block diagram illustrating the architecture of one embodiment of a mobile computing device. That is, the mobile computing device 1200 can incorporate a system 1202 (i.e., an architecture) to implement some embodiments. In one embodiment, the system 1202 is implemented as a “smart phone” capable of running one or more applications (e.g., browser, e-mail, calendaring, contact managers, messaging clients, games, and media clients/players). In some embodiments, the system 1202 is integrated as a computing device, such as an integrated personal digital assistant (PDA) and wireless phone.

One or more application programs 1266 may be loaded into the memory 1262 and run on or in association with the operating system 1264. Examples of the application programs include phone dialer programs, e-mail programs, personal information management (PIM) programs, word processing programs, spreadsheet programs, Internet browser programs, messaging programs, and so forth. The system 1202 also includes a non-volatile storage area 1268 within the memory 1262. The non-volatile storage area 1268 may be used to store persistent information that should not be lost if the system 1202 is powered down. The application programs 1266 may use and store information in the non-volatile storage area 1268, such as e-mail or other messages used by an e-mail application, and the like. A synchronization application (not shown) also resides on the system 1202 and is programmed to interact with a corresponding synchronization application resident on a host computer to keep the information stored in the non-volatile storage area 1268 synchronized with corresponding information stored at the host computer. As should be appreciated, other applications may be loaded into the memory 1262 and run on the mobile computing device 1200, including the model manager 26 as described herein.

The system 1202 has a power supply 1270, which may be implemented as one or more batteries. The power supply 1270 might further include an external power source, such as an AC adapter or a powered docking cradle that supplements or recharges the batteries.

The system 1202 may also include a radio 1272 that performs the function of transmitting and receiving radio frequency communications. The radio 1272 facilitates wireless connectivity between the system 1202 and the “outside world,” via a communications carrier or service provider. Transmissions to and from the radio 1272 are conducted under control of the operating system 1264. In other words, communications received by the radio 1272 may be disseminated to the application programs 1266 via the operating system 1264, and vice versa.

The visual indicator 1220 may be used to provide visual notifications, and/or an audio interface 1274 may be used for producing audible notifications via the audio transducer 1225. In the illustrated embodiment, the visual indicator 1220 is a light emitting diode (LED) and the audio transducer 1225 is a speaker. These devices may be directly coupled to the power supply 1270 so that when activated, they remain on for a duration dictated by the notification mechanism even though the processor 1260 and other components might shut down for conserving battery power. The LED may be programmed to remain on indefinitely until the user takes action to indicate the powered-on status of the device. The audio interface 1274 is used to provide audible signals to and receive audible signals from the user. For example, in addition to being coupled to the audio transducer 1225, the audio interface 1274 may also be coupled to a microphone to receive audible input, such as to facilitate a telephone conversation. In accordance with embodiments of the present invention, the microphone may also serve as an audio sensor to facilitate control of notifications, as will be described below. The system 1202 may further include a video interface 1276 that enables an operation of an on-board camera to record still images, video stream, and the like.

A mobile computing device 1200 implementing the system 1202 may have additional features or functionality. For example, the mobile computing device 1200 may also include additional data storage devices (removable and/or non-removable) such as, magnetic disks, optical disks, or tape. Such additional storage is illustrated in FIG. 7B by the non-volatile storage area 1268. Mobile computing device 1200 may also include peripheral device port 1230.

Data/information generated or captured by the mobile computing device 1200 and stored via the system 1202 may be stored locally on the mobile computing device 1200, as described above, or the data may be stored on any number of storage media that may be accessed by the device via the radio 1272 or via a wired connection between the mobile computing device 1200 and a separate computing device associated with the mobile computing device 1200, for example, a server computer in a distributed computing network, such as the Internet. As should be appreciated such data/information may be accessed via the mobile computing device 1200 via the radio 1272 or via a distributed computing network. Similarly, such data/information may be readily transferred between computing devices for storage and use according to well-known data/information transfer and storage means, including electronic mail and collaborative data/information sharing systems.

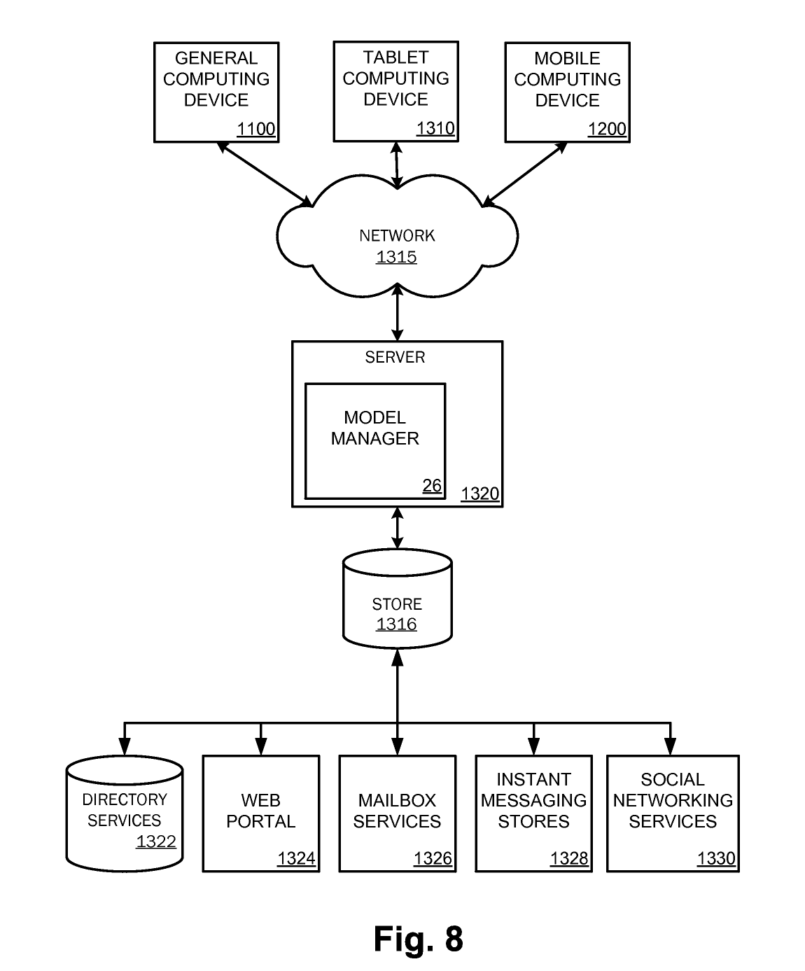

FIG. 8 illustrates an embodiment of an architecture of an exemplary system, as described above. Content developed, interacted with, or edited in association with the model manager 26 may be stored in different communication channels or other storage types. For example, various documents may be stored using a directory service 1322, a web portal 1324, a mailbox service 1326, an instant messaging store 1328, or a social networking site 1330. The model manager 26 may use any of these types of systems or the like for enabling data utilization, as described herein. A server 1320 may provide the model manager 26 to clients. As one example, the server 1320 may be a web server providing the model manager 26 over the web. The server 1320 may provide the model manager 26 over the web to clients through a network 1315. By way of example, the client computing device may be implemented as the computing device 1100 and embodied in a personal computer, a tablet computing device 1310 and/or a mobile computing device 1200 (e.g., a smart phone). Any of these embodiments of the client computing device 1100, 1310, and 1200 may obtain content from the store 1316.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

What is claimed is:

1. A method using results from different language models, comprising:
receiving language model results including a language model recognition output in response to performing recognition on an utterance using a language model;
receiving adapted language model results including an adapted language model recognition output in response to performing recognition on the utterance using an adapted language model;
selecting the language model results in response to an automatic determination that determines that the language model results are more likely to be accurate as compared to the adapted language model results; and
selecting the adapted language model results in response to the automatic determination that determines that the adapted language model results are more likely to be accurate as compared to the language model results.

2. The method of claim 1, further comprising extracting features from the language model results and extracting features from the adapted language model results, including determining a language model score and an adapted language model score.

3. The method of claim 1, further comprising selecting the language model results before performing the recognition on the utterance using the adapted language model in response to an automatic determination that the language model results are accurate and selecting the adapted language model results before performing the recognition on the utterance using the language model in response to an automatic determination that the adapted language model results are accurate.

4. The method of claim 1, wherein the automatic determination comprises applying a statistical classifier to features extracted from the language model results and the adapted language model results.

5. The method of claim 1, further comprising extracting features from the language model results and extracting features from the adapted language model results including extracting at least one of: a recognition confidence associated with the recognition using the language model and the recognition using the adapted language model; or quality measurements of audio data of the utterance.

6. The method of claim 1, wherein the automatic determination comprises computing a log likelihood score using the language model recognition output and the adapted language recognition output.

7. The method of claim 1, wherein performing the recognition on the utterance using the language model and performing the recognition on the utterance using the adapted language model occurs in parallel.

8. The method of claim 1, further comprising training a language model using utterances weighted differently in response to the language model results being selected.

9. The method of claim 8, further comprising computing statistics including determining Ngram differences using the language model results and the adapted language model results to determine weights to associate with the utterances.

10. A computer-readable medium storing computer-executable instructions for using results from different language models, comprising:
performing recognition on an utterance using different language models;
receiving results associated with each performed recognition using the different language models;
extracting features from the results including determining language model scores associated with each of the different language models; and
selecting results associated with one of the different language models in response to an automatic determination using a statistical classifier applied to the results.

11. The computer-readable medium of claim 10, wherein the different language models consist of a baseline language model and an adapted language model.

12. The computer-readable medium of claim 10, wherein the statistical classifier is trained using features extracted from language model results and adapted language model results.

13. The computer-readable medium of claim 10, wherein extracting the features comprises determining an acoustic model score and determining quality measurements of audio data of the utterance.

14. The computer-readable medium of claim 10, wherein selecting the results comprises determining a recognition confidence associated with each of the different language models.

15. The computer-readable medium of claim 10, wherein performing the recognition on the utterance using the different language models occurs in parallel.

16. The computer-readable medium of claim 10, further comprising retraining an adapted language model using utterances in training data weighted differently in response to statistics determined from the results received associated with the different language models.

17. A system for using results from different language models, comprising:
a processor and memory;
an operating environment executing using the processor; and
a model manager that is configured to perform actions comprising:
receiving an utterance;
performing recognition on the utterance using a language model and an adapted language model;
receiving language model results and adapted language model results in response to performing the recognition on the utterance using the language model and the adapted language model;
extracting features from the language model results and the adapted language model results, comprising a language model score and an adapted language model score that each indicate a likelihood of the result given the associated language model; and
determining when to select the language model results and when to select the adapted language model results using a statistical classifier.

18. The system of claim 17, wherein extracting the features comprises determining recognition confidences associated with performing the recognition on the utterance using the language model and performing the recognition on the utterance using the adapted language model.

19. The system of claim 17, further comprising training a language model using utterances in a training data set weighted differently in response to differences between language model results and adapted language model results.

20. The system of claim 17, further comprising retraining the adapted language model with the utterance weighted differently in response to the language model results being selected; and determining Ngram differences between the language model results and the adapted language model results.
